(19) United States
(12) Patent Application Publication
(10) Pub. No.: US 2026/0296264 A1
(43) Pub. Date: Oct. 1, 2026

(54) POWER MANAGEMENT DEVICE

(71) Applicants: Hino Motors, Ltd., Tokyo (JP); TOYOTA JIDOSHA KABUSHIKI KAISHA, Toyota-shi (JP)

(72) Inventors: Hiroki TORII, Tokyo (JP); Ryota KAWAGUCHI, Tokyo (JP); Akihiro TANUMA, Tokyo (JP)

(73) Assignees: Hino Motors, Ltd., Tokyo (JP); TOYOTA JIDOSHA KABUSHIKI KAISHA, Toyota-shi (JP)

(21) Appl. No.: 19/557,978

(22) Filed: Mar. 5, 2026

(30) Foreign Application Priority Data
Mar. 28, 2025 (JP) 2025-056902

(51) Int. Cl. B60L 58/15; H02J 7/14

(52) U.S. Cl. CPC B60L 58/15; H02J 7/14

(57) ABSTRACT

A power management device includes a control unit configured to control, based on a state of charge of a battery, a priority of distribution of regenerative electric power in an electric vehicle including the battery and an electric power device, the distribution being to charging the battery to a continuous rating or to a charge amount lower than the continuous rating, charging the battery to a short-time rating, or electric power consumption at the electric power device.

### CROSS-REFERENCE TO RELATED APPLICATIONS

This application is based upon and claims the benefit of priority from Japanese Patent Application No. 2025-056902, filed on Mar. 28, 2025, the entire contents of which are incorporated herein by reference.

### TECHNICAL FIELD

One aspect of the disclosure relates to a power management device configured to control a priority of distribution of regenerative electric power in an electric vehicle.

### BACKGROUND

Japanese Unexamined Patent Application No. 2021-154911 discloses a vehicle air conditioner including a circuit switching control unit configured to switch a circuit in accordance with a remaining capacity of a battery that is regeneratively charged during vehicle travel, in a vehicle equipped with a battery configured to supply electric power to an electric motor.

### SUMMARY

In the above vehicle air conditioner, when the battery is regeneratively charged, the continuous rating or the short-time rating of the battery is not considered, and appropriate charging may not be performed. Therefore, it is desired to more appropriately control distribution of regenerative electric power.

A power management device according to one aspect of the disclosure includes a control unit configured to control, based on a state of charge of a battery, a priority of distribution of regenerative electric power in an electric vehicle including the battery and an electric power device, the distribution being to: charging the battery to a continuous rating or to a charge amount lower than the continuous rating; charging the battery to a short-time rating; or electric power consumption at the electric power device. According to the above aspect, the priority of the distribution of regenerative electric power in the electric vehicle, the distribution being to charging the battery to the continuous rating or to the charge amount lower than the continuous rating, charging the battery to the short-time rating, or electric power consumption at the electric power device, is controlled based on the state of charge of the battery. Thereby, distribution of regenerative electric power is controlled in consideration of the continuous rating or the short-time rating of the battery. That is, the distribution of regenerative electric power can be more appropriately controlled.

In the power management device according to one aspect of the disclosure, the control unit may control the priority based on comparison between the state of charge and one or more predetermined thresholds. According to this aspect, distribution of regenerative electric power can be more simply and more reliably controlled based on comparison between the state of charge and the threshold.

In the power management device according to one aspect of the disclosure, the control unit may change at least one of the one or more thresholds based on the regenerative electric power required by the electric vehicle. According to this aspect, distribution of regenerative electric power can be more appropriately controlled based on the regenerative electric power required by the electric vehicle.

In the power management device according to one aspect of the disclosure, when the state of charge is smaller than a predetermined threshold, the control unit may prioritize charging the battery to the continuous rating or to a charge amount lower than the continuous rating over charging the battery to the short-time rating. Generally, at a low state of charge, since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is smaller than a predetermined threshold, the control unit may prioritize charging the battery to the short-time rating over the electric power consumption. Generally, at a low state of charge, since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is smaller than a predetermined threshold, the control unit may prioritize charging the battery to the continuous rating or to a charge amount lower than the continuous rating over the electric power consumption. Generally, at a low state of charge, since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is greater than a predetermined first threshold and smaller than a predetermined second threshold, the control unit may prioritize charging the battery to the continuous rating or to a charge amount lower than the continuous rating over the electric power consumption. Generally, at a medium state of charge (as compared with a high state of charge), since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is greater than a predetermined first threshold and smaller than a predetermined second threshold, the control unit may prioritize the electric power consumption over charging the battery to the short-time rating. Generally, at a medium state of charge (as compared with a high state of charge), since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is greater than a predetermined first threshold and smaller than a predetermined second threshold, the control unit may prioritize charging the battery to the continuous rating or to a charge amount lower than the continuous rating over charging the battery to the short-time rating. Generally, at a medium state of charge (as compared with a high state of charge), since the continuous rating is large, braking force is unlikely to be insufficient. According to this aspect, distribution of regenerative electric power can be more appropriately controlled, for example, braking force can be secured, a margin of the short-time rating can be secured, and fuel consumption can be reduced.

In the power management device according to one aspect of the disclosure, when the state of charge is greater than a predetermined threshold, the control unit may prioritize the electric power consumption over charging the battery to the continuous rating or to a charge amount lower than the continuous rating. According to this aspect, distribution of regenerative electric power can be more appropriately controlled, for example, a margin of the short-time rating can be secured, and thereby braking force can be secured.

In the power management device according to one aspect of the disclosure, when the state of charge is greater than a predetermined threshold, the control unit may prioritize charging the battery to the continuous rating or to a charge amount lower than the continuous rating over charging the battery to the short-time rating. According to this aspect, distribution of regenerative electric power can be more appropriately controlled, for example, a margin of the short-time rating can be secured, and thereby braking force can be secured.

In the power management device according to one aspect of the disclosure, when the state of charge is greater than a predetermined threshold, the control unit may prioritize the electric power consumption over charging the battery to the short-time rating. According to this aspect, distribution of regenerative electric power can be more appropriately controlled, for example, a margin of the short-time rating can be secured, and thereby braking force can be secured.

In the power management device according to one aspect of the disclosure, the control unit may change the threshold based on the regenerative electric power required by the electric vehicle. According to this aspect, distribution of regenerative electric power can be more appropriately controlled based on the regenerative electric power required by the electric vehicle.

In the power management device according to one aspect of the disclosure, the control unit may change at least one of the first threshold and the second threshold based on the regenerative electric power required by the electric vehicle. According to this aspect, distribution of regenerative electric power can be more appropriately controlled based on the regenerative electric power required by the electric vehicle.

According to one aspect of the disclosure, distribution of regenerative electric power can be more appropriately controlled.

### BRIEF DESCRIPTION OF THE DRAWINGS

FIG. 1 is a diagram showing an example of a configuration of a fuel cell vehicle including an example of a functional configuration of a power management device according to an embodiment.

FIG. 2 is a graph illustrating battery characteristics.

FIG. 3 is a graph illustrating powering side constraints.

FIG. 4 is a graph illustrating regeneration side constraints.

FIG. 5 is a graph illustrating supply and consumption by SOC when required regenerative output is large.

FIG. 6 is a graph illustrating supply and consumption by SOC when required regenerative output is medium.

FIG. 7 is a graph illustrating supply and consumption by SOC when required regenerative output is small.

FIG. 8 is a flowchart showing an example of processing executed by the power management device according to the embodiment.

### DETAILED DESCRIPTION

Hereinafter, embodiments of the disclosure will be described in detail with reference to the drawings. In the description of the drawings, the same elements are denoted by the same reference numerals, and duplicate descriptions are omitted. The embodiments of the disclosure in the following description are specific examples of the invention, and are not limited to these embodiments unless otherwise specified to limit the invention.

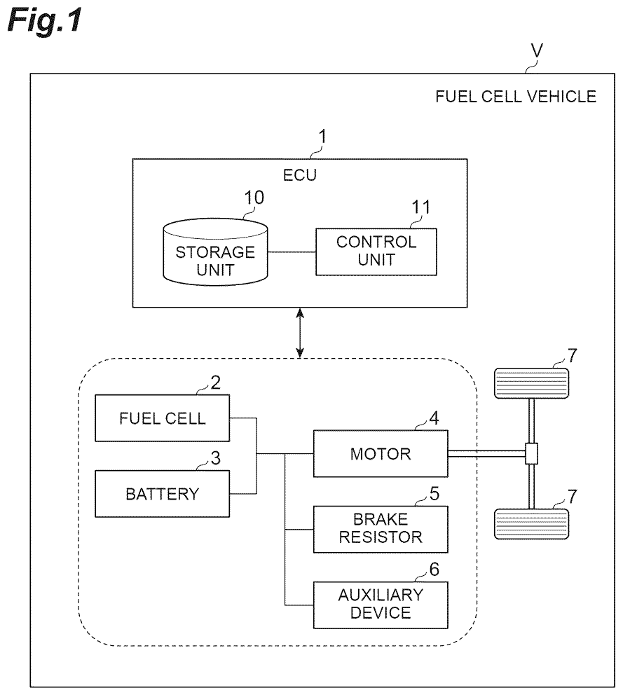

FIG. 1 is a diagram showing an example of a configuration of a fuel cell vehicle V (electric vehicle) including an example of a functional configuration of an ECU 1 (power management device) according to the embodiment. As shown in FIG. 1, the fuel cell vehicle V is configured to include the ECU 1, a fuel cell 2, a battery 3 (battery), a motor 4, a brake resistor 5 (electric power device), an auxiliary device 6 (electric power device), and tires 7.

The fuel cell vehicle V, the fuel cell 2, the battery 3, the motor 4, the brake resistor 5, the auxiliary device 6, and the tires 7 are assumed to be a general fuel cell vehicle, a fuel cell (mounted on the fuel cell vehicle), a battery (mounted on the fuel cell vehicle), a motor (mounted on the fuel cell vehicle), a brake resistor (mounted on the fuel cell vehicle), an auxiliary device (mounted on the fuel cell vehicle), and tires (of the fuel cell vehicle), respectively, but are not limited thereto. In the embodiment, descriptions of general processing performed by general technical configurations are omitted.

The fuel cell vehicle V is not limited to a fuel cell vehicle, and may be replaced with any electric vehicle including at least a battery and an electric power device, such as an electric vehicle (EV), a hybrid vehicle, or a fuel cell truck.

The ECU 1 is based on a general electronic control unit (ECU) and further includes functions described later.

The auxiliary device 6 includes a pump for circulating cooling water to cool the fuel cell system, a fan for cooling the fuel cell system, and the like. In FIG. 1, the brake resistor 5 and the auxiliary device 6 are described as different configurations, but the auxiliary device 6 may include the brake resistor 5. That is, in the embodiment, the “auxiliary device 6” may not include the brake resistor 5, or may include the brake resistor 5. In the embodiment, the “brake resistor 5” may not include the auxiliary device 6, or may include the auxiliary device 6.

Here, background or premises will be described.

Characteristics of a general battery will be described. Charging limitations of the battery include a continuous rating (small chargeable amount) and a short-time rating (large chargeable amount). The continuous rating is an allowable electric power at which the battery can be constantly charged, and the unit is kW. The short-time rating is an allowable electric power at which the battery can be charged and discharged for a short time, and the unit is kW. When the battery is charged and discharged with an electric power equal to or greater than that of the short-time rating, deterioration of the battery is accelerated, or in the worst case, the battery ignites.

Allowable charging power according to the short-time rating decreases due to battery charging, and finally decreases to that of the continuous rating. That is, the battery has a characteristic that when charged in excess of the continuous rating, the chargeable amount decreases from that of the short-time rating to that of the continuous rating. The larger the amount exceeding the continuous rating, the faster the time for the chargeable amount to decrease from that of the short-time rating to that of the continuous rating. On the other hand, when the battery is charged within the electric power of the continuous rating, the influence on the charging continuation time using the short-time rating is small, and the use of the short-time rating can be secured. When the battery is left unused, the state in which the short-time rating can be used gradually returns.

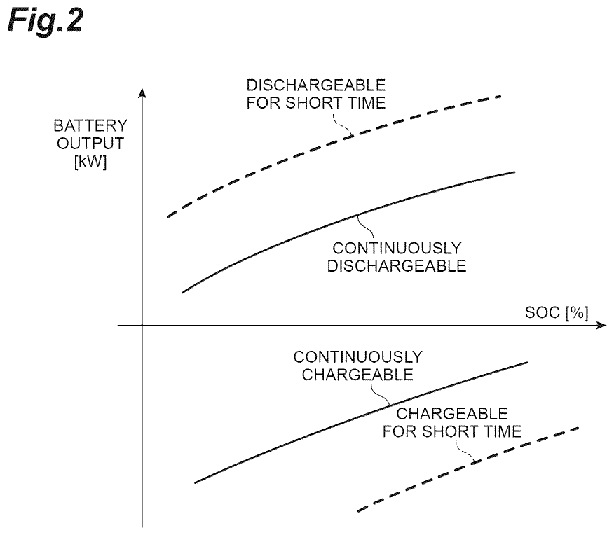

FIG. 2 is a graph illustrating battery characteristics. The horizontal axis of the graph is the state of charge (SOC) of the battery, and the unit is %. The vertical axis of the graph is battery output, and the unit is kW. The solid line of the graph indicates a battery output that can be continuously discharged at a certain SOC when the battery output is positive, and indicates the battery output that can be continuously charged at a certain SOC when the battery output is negative. The broken line of the graph indicates a battery output that can be discharged for a short time at a certain SOC when the battery output is positive, and indicates a battery output that can be charged for a short time at a certain SOC when the battery output is negative. The graph shows that on the powering side (driving side), the lower the SOC, the more difficult it is to obtain battery output, and the higher the SOC, the easier it is to obtain battery output. The graph shows that on the charging side, the lower the SOC, the greater the allowable charging electric power, and the higher the SOC, the lower the allowable charging electric power.

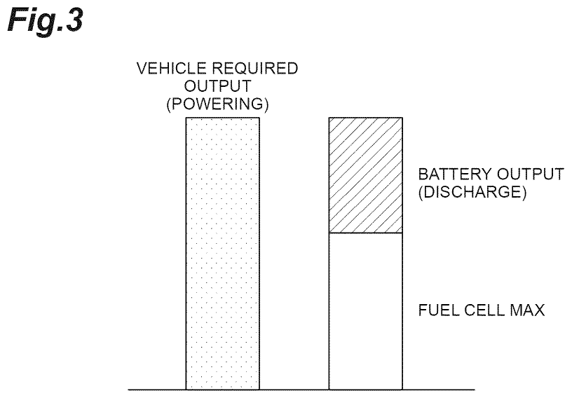

FIG. 3 is a graph illustrating powering side constraints. The graph shows that battery output (discharge) is required when the fuel cell (maximum) output alone does not satisfy the vehicle required output. As described above, since the battery continuous rating output has a characteristic of being decreased when the SOC is low, it is necessary to control the SOC to be equal to or greater than a predetermined threshold.

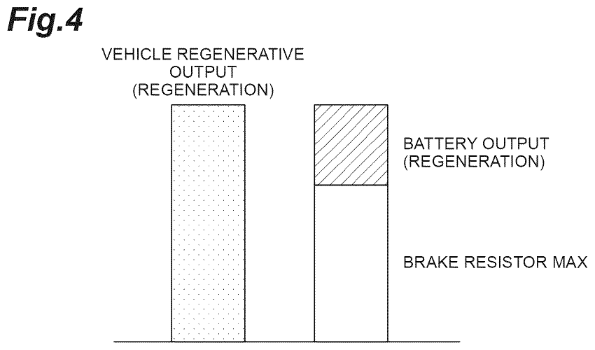

FIG. 4 is a graph illustrating regeneration side constraints. The graph shows that battery charging is required when the brake resistor 5 (or the auxiliary device 6) alone does not satisfy the required vehicle regenerative output. As described above, when the SOC is high, the battery continuous rating output becomes small, so it is necessary to control the SOC to be equal to or less than a predetermined threshold.

Returning to FIG. 1, the fuel cell vehicle V obtains the electric power necessary for driving the motor 4 from both the fuel cell 2 and the battery 3. On the other hand, the fuel cell vehicle V consumes the electric power of regenerative output generated from the motor 4 during deceleration using the battery 3 and the brake resistor 5.

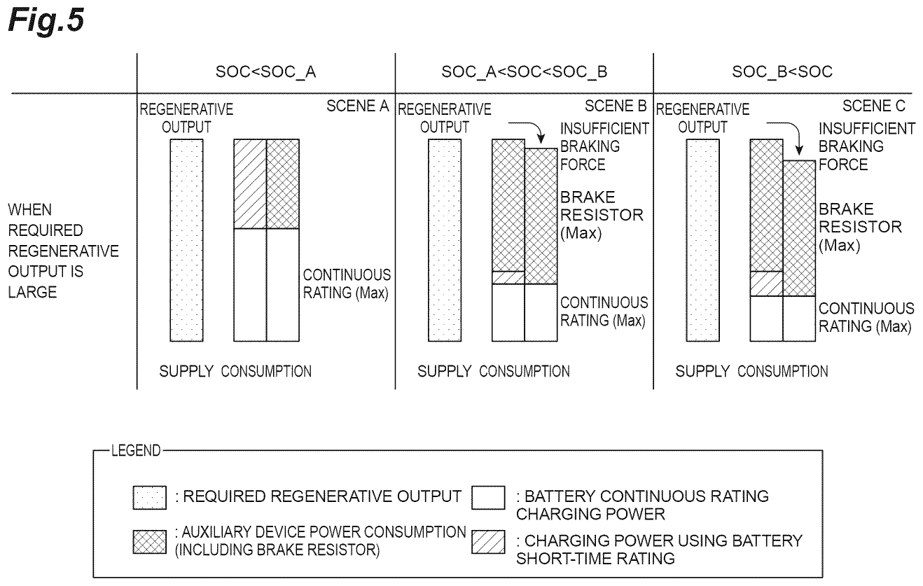

Regenerative output varies depending on the braking force required by a driver, for example, due to a downhill road gradient. For this reason, for a vehicle system of the fuel cell vehicle V, it is necessary to distribute the required regenerative output to charging the battery 3 and electric power consumption of the brake resistor 5. For example, there is a case where the short-time rating cannot be used due to continuous use of the battery, and the continuous rating and the electric power consumption of the brake resistor 5 are insufficient for the regenerative output (see Scene B and Scene C in FIG. 5 described later). In this case, the fuel cell vehicle V uses a friction brake, and there is a risk that braking force becomes insufficient due to a fade phenomenon when used for a long time.

As described above, as a battery characteristic, when the SOC is high, the chargeable amount of the battery decreases, so regenerative power, which is the sum of the battery charging amount and the power consumption of the brake resistor 5, also decreases, and there is a risk that the necessary braking force cannot be obtained. As a result, it becomes necessary to use a friction brake, and in the worst case, there is a risk of brake fade in continuous descents.

The background or premises have been described above.

Details of the ECU 1 will be described below. The ECU 1 controls the priority of distribution of regenerative electric power in the fuel cell vehicle V. The ECU 1 is, for example, an electronic control unit having a central processing unit (CPU), a read only memory (ROM), a random access memory (RAM), a controller area network (CAN) communication circuit, and the like. In the ECU 1, for example, various functions are realized by loading a program stored in the ROM into the RAM and executing the program loaded in the RAM by the CPU.

As shown in FIG. 1, the ECU 1 is configured to include a storage unit 10 and a control unit 11 (control unit). Each functional block of the ECU 1 is assumed to function within the ECU 1, but is not limited thereto. For example, some of the functional blocks of the ECU 1 may be a computer device different from the ECU 1, and may function within a computer device connected to the ECU 1 via a network while appropriately transmitting and receiving information to and from the ECU 1. Some functional blocks of the ECU 1 may be omitted, a plurality of functional blocks may be integrated into one functional block, or one functional block may be divided into a plurality of functional blocks.

The storage unit 10 stores arbitrary information used or output in processing of the ECU 1 and the like. The storage unit 10 may store information calculated by each function of the ECU 1. Information stored by the storage unit 10 may be appropriately referenced by each function of the ECU 1.

The control unit 11 controls, based on the state of charge of the battery 3, the priority of distribution of regenerative electric power in the fuel cell vehicle V, the distribution being to charging the battery 3 to the continuous rating or to a charge amount lower than the continuous rating (a charge amount lower than the continuous rating by a predetermined charge amount), charging the battery 3 to the short-time rating, or electric power consumption at the brake resistor 5. More specifically, the control unit 11 controls, based on the state of charge of the battery 3, the priority of distribution of regenerative electric power in the fuel cell vehicle V to three destinations: (1) charging the battery 3 to the continuous rating or to a charge amount lower than the continuous rating, (2) charging the battery 3 to the short-time rating, or (3) electric power consumption at the brake resistor 5.

The control unit 11 may control the priority based on comparison between the state of charge and one or more predetermined thresholds. For example, the control unit 11 may control the priority based on comparison between the state of charge and one predetermined threshold. For example, the control unit 11 may control the priority based on comparison between the state of charge and two predetermined thresholds (for example, SOC_A and SOC_B described later). The control unit 11 may change at least one of the one or more thresholds (described above) based on regenerative electric power required by the fuel cell vehicle V.

When the state of charge is smaller than a predetermined threshold (for example, SOC_A described later), the control unit 11 may prioritize charging to the continuous rating or to a charge amount lower than the continuous rating over charging to the short-time rating. When the state of charge is smaller than a predetermined threshold (for example, SOC_A described later), the control unit 11 may prioritize charging to the short-time rating over electric power consumption. When the state of charge is smaller than a predetermined threshold (for example, SOC_A described later), the control unit 11 may prioritize charging to the continuous rating or to a charge amount lower than the continuous rating over electric power consumption. The control unit 11 may change the threshold (described above) (for example, SOC_A described later) based on regenerative electric power required by the fuel cell vehicle V.

When the state of charge is greater than a predetermined first threshold (for example, SOC_A described later) and smaller than a predetermined second threshold (for example, SOC_B described later), the control unit 11 may prioritize charging to the continuous rating or to a charge amount lower than the continuous rating over electric power consumption. When the state of charge is greater than a predetermined first threshold (for example, SOC_A described later) and smaller than a predetermined second threshold (for example, SOC_B described later), the control unit 11 may prioritize electric power consumption over charging to the short-time rating. When the state of charge is greater than a predetermined first threshold (for example, SOC_A described later) and smaller than a predetermined second threshold (for example, SOC_B described later), the control unit 11 may prioritize charging to the continuous rating or to a charge amount lower than the continuous rating over charging to the short-time rating. The control unit 11 may change at least one of the first threshold (described above) (for example, SOC_A described later) and the second threshold (described above) (for example, SOC_B described later) based on regenerative electric power required by the fuel cell vehicle V.

When the state of charge is greater than a predetermined threshold (for example, SOC_B described later), the control unit 11 may prioritize electric power consumption over charging to the continuous rating or to a charge amount lower than the continuous rating. When the state of charge is greater than a predetermined threshold (for example, SOC_B described later), the control unit 11 may prioritize charging to the continuous rating or to a charge amount lower than the continuous rating over charging to the short-time rating. When the state of charge is greater than a predetermined threshold (for example, SOC_B described later), the control unit 11 may prioritize electric power consumption over charging to the short-time rating. The control unit 11 may change the threshold (described above) (for example, SOC_B described later) based on regenerative electric power required by the fuel cell vehicle V.

The control unit 11 may perform the distribution in accordance with the priority after setting or changing the priority of distribution of regenerative electric power in the fuel cell vehicle V.

The control unit 11, for example, focuses on necessary braking force (regenerative output), secures a margin (holding time) of the battery short-time rating, and switches the priority of distribution destinations of regenerative output, which are charging the battery 3 to the short-time rating, charging the battery 3 to the continuous rating or to a charge amount lower than the continuous rating, or electric power consumption of the brake resistor 5, by SOC in order to obtain necessary braking force for a necessary time in continuous descents on a travel route.

For example, when the predetermined threshold is SOC_A and the SOC of the battery 3 satisfies the formula “SOC<SOC_A”, the control unit 11 may control the priority of distribution of regenerative electric power in the fuel cell vehicle V as follows: “charging the battery 3 to the continuous rating or to a charge amount lower than the continuous rating>charging the battery 3 to the short-time rating>electric power consumption at the brake resistor 5” (that is, prioritizing charging the battery 3 to the continuous rating or to a charge amount lower than the continuous rating over charging the battery 3 to the short-time rating, and prioritizing charging the battery 3 to the short-time rating over electric power consumption at the brake resistor 5).

For example, when the predetermined first threshold is SOC_A, the predetermined second threshold is SOC_B (where SOC_A<SOC_B), and the SOC of the battery 3 satisfies the formula “SOC_A<SOC<SOC_B”, the control unit 11 may control the priority of distribution of regenerative electric power in the fuel cell vehicle V as follows: “charging the battery 3 to the continuous rating or to a charge amount lower than the continuous rating>electric power consumption at the brake resistor 5 >charging the battery 3 to the short-time rating” (that is, prioritizing charging the battery 3 to the continuous rating or to a charge amount lower than the continuous rating over electric power consumption at the brake resistor 5, and prioritizing electric power consumption at the brake resistor 5 over charging the battery 3 to the short-time rating).

For example, when the predetermined threshold is SOC_B and the SOC of the battery 3 satisfies the formula “SOC_B<SOC”, the control unit 11 may control the priority of distribution of regenerative electric power in the fuel cell vehicle V as follows: “electric power consumption at the brake resistor 5 >charging the battery 3 to the continuous rating or to a charge amount lower than the continuous rating>charging the battery 3 to the short-time rating” (that is, prioritizing electric power consumption at the brake resistor 5 over charging the battery 3 to the continuous rating or to a charge amount lower than the continuous rating, and prioritizing charging the battery 3 to the continuous rating or to a charge amount lower than the continuous rating over charging the battery 3 to the short-time rating).

FIG. 5 is a graph illustrating supply and consumption by SOC when required regenerative output is large. As shown in FIG. 5, a graph is shown for each of three scenes according to SOC. The three scenes are Scene A in the case of “SOC<SOC_A” described above, Scene B in the case of “SOC_A<SOC<SOC_B” described above, and Scene C in the case of “SOC_B<SOC” described above. The bar graph on the left side of each scene shows supply, and the two bar graphs on the right side show consumption. A state after a certain time has elapsed from the state shown in the left bar graph of the two bar graphs on the right side corresponds to the right bar graph of the two bar graphs.

For example, in Scene A, initially, about half of the supplied regenerative output is consumed by charging the battery 3 to the continuous rating (or to a charge amount lower than the continuous rating), and the remaining about half is consumed by charging the battery 3 to the short-time rating. After a certain time has elapsed, about half of the supplied regenerative output is (continuously) consumed by charging the battery 3 to the continuous rating (or to a charge amount lower than the continuous rating), and the remaining about half is consumed by electric power consumption at the brake resistor 5.

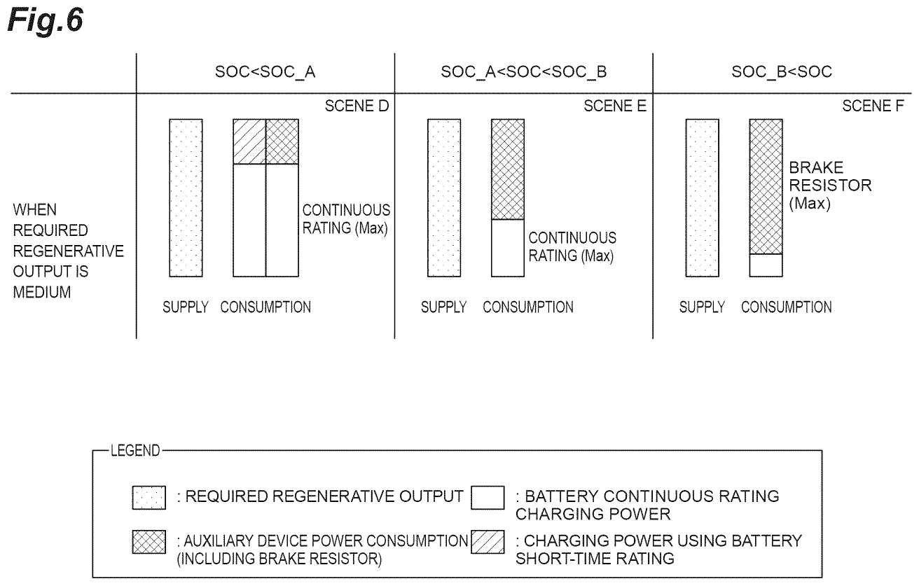

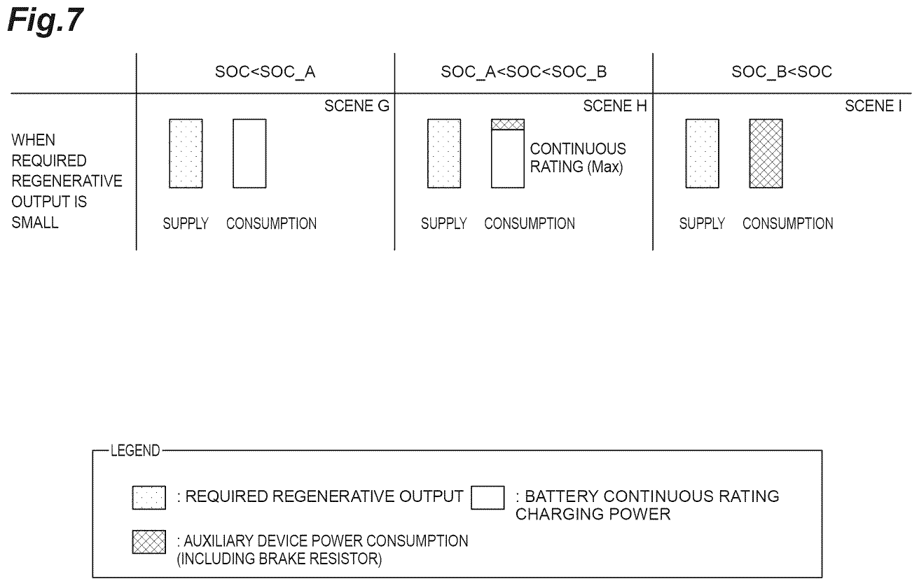

FIG. 6 is a graph illustrating supply and consumption by SOC when required regenerative output is medium. FIG. 7 is a graph illustrating supply and consumption by SOC when required regenerative output is small. The formats of FIGS. 6 and 7 are the same as the format of FIG. 5, and thus descriptions thereof are omitted.

For example, in a high SOC region of “SOC_B<SOC”, when a change is made from Scene F where required braking force increases to Scene C, since a margin of the short-time rating is left before transitioning to Scene C, the short-time rating can be utilized to the maximum after transitioning to Scene C, and the risk and frequency of insufficient braking force can be reduced.

For example, in a medium SOC region of “SOC_A<SOC<SOC_B”, the continuous rating is larger as compared with high SOC, and even when the required braking force increases and a transition is made from Scene E to Scene B, the risk and frequency of insufficient braking force can be further reduced. Furthermore, in Scene E, since power consumption at the brake resistor 5 can be reduced as compared with Scene F, fuel consumption can also be reduced.

For example, in a low SOC region of “SOC<SOC_A”, since the continuous rating is large and braking force is not insufficient, fuel consumption can be reduced by prioritizing the short-time rating over consumption at the brake resistor 5, and the SOC can be controlled high. In this case, even when the vehicle state changes from regeneration to powering, the continuous rating on the discharge side of the battery 3 becomes high, and driving force can be secured.

As described above, with a minimum system configuration including the battery 3 and the brake resistor 5, regenerative braking force necessary for the fuel cell vehicle V is secured, and securing of driving force and suppression of deterioration of fuel efficiency can be achieved together.

Another control by the control unit 11 will be described. The control unit 11 may variably control the priority of distribution of regenerative electric power to charging the battery 3 and electric power consumption at the brake resistor 5 according to the SOC of the battery 3 as follows. For example, at high SOC (for example, “SOC_B<SOC”), the control unit 11 distributes regenerative output by prioritizing electric power consumption at the brake resistor 5. For example, at medium SOC (for example, “SOC_A<SOC<SOC_B”), the control unit 11 prioritizes charging the battery 3 with regenerative electric power to a charging limit (continuous rating) or to a charge amount lower than the charging limit, and then prioritizes and distributes electric power consumption at the brake resistor 5. For example, at low SOC (for example, “SOC<SOC_A”), the control unit 11 prioritizes and distributes regenerative electric power to charging the battery 3 to a charging limit (short-time rating).

The control unit 11 may provide a hysteresis or a transition region between each SOC (may smooth a boundary portion of each threshold). For example, the control unit 11 may provide a hysteresis or a transition region in at least one of SOC_A and SOC_B.

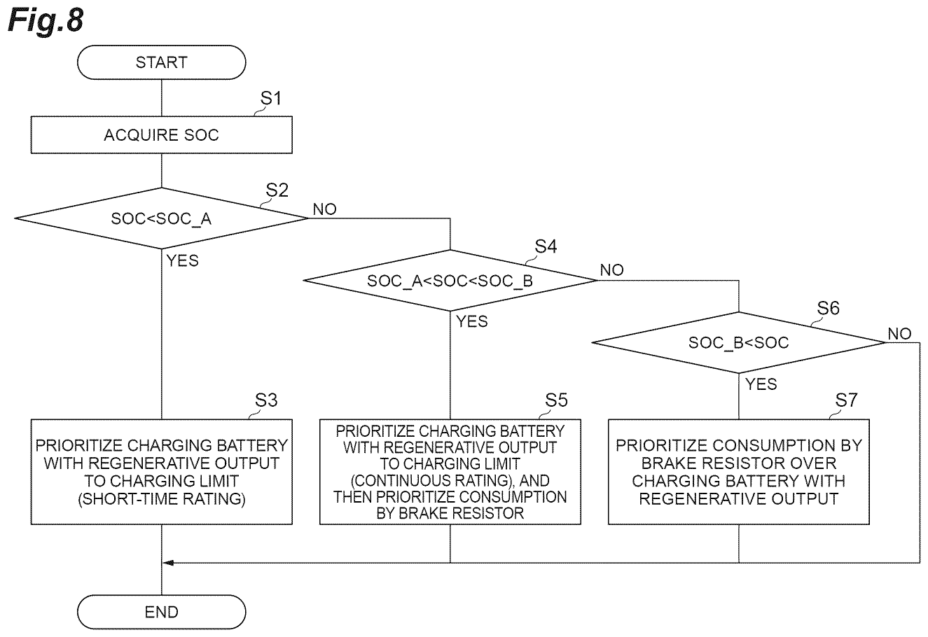

FIG. 8 is a flowchart showing an example of processing (power management method) executed by the ECU 1. First, the control unit 11 acquires the SOC of the battery 3 (step S1). Next, the control unit 11 determines whether the SOC acquired in S1 is smaller than SOC_A (step S2). When it is determined in S2 that the SOC is smaller (S2: YES), the control unit 11 prioritizes charging the battery 3 with regenerative output to a charging limit (short-time rating) (step S3), and ends the processing.

On the other hand, when it is determined in S2 that the SOC is not smaller (S2: NO), the control unit 11 determines whether the SOC acquired in S1 is greater than SOC_A and smaller than SOC_B (step S4). When it is determined in S4 that the SOC is greater and smaller (S4: YES), the control unit 11 prioritizes charging the battery 3 with regenerative output to a charging limit (continuous rating) or to a charge amount lower than the charging limit, and then prioritizes consumption at the brake resistor 5 (step S5), and ends the processing.

On the other hand, when it is determined in S4 that the SOC is not greater and not smaller (the SOC acquired in S1 is not greater than SOC_A or is not smaller than SOC_B) (S4: NO), the control unit 11 determines whether the SOC acquired in S1 is greater than SOC_B (step S6). When it is determined in S6 that the SOC is greater (S6: YES), the control unit 11 prioritizes consumption at the brake resistor 5 over charging the battery 3 with regenerative output (step S7), and ends the processing. On the other hand, when it is determined in S6 that the SOC is not greater (S6: NO), the processing ends. In a region equal to or less than the SOC threshold (for example, SOC_A), when regenerative output is small, the battery 3 may be charged from the fuel cell 2.

Details of a point that the control unit 11 changes the threshold based on regenerative electric power required by the fuel cell vehicle V will be described. Since regenerative electric power depends on road gradient, the control unit 11 may acquire, for example, information from a global positioning system (GPS) device, information from a navigation system, or traffic jam information, and variably control the SOC threshold.

Here, necessary braking force and regenerative output [kW] that satisfies the braking force vary depending on vehicle speed, vehicle weight, road gradient, and the like. When the control unit 11 estimates a route to be traveled by a GPS device, a navigation system, or the like and predicts a road gradient, necessary braking force [N] and regenerative output [kW] that satisfies the braking force can also be predicted.

In order to obtain necessary regenerative output, the control unit 11 may prioritize consumption at the brake resistor 5 over charging the battery 3 in a region where the SOC of the battery 3 is equal to or greater than a threshold (high SOC region), but when required regenerative electric power predicted from a GPS device, a navigation system, or the like is small in a predicted section, SOC_B and/or SOC_A can be increased to reduce an SOC region where consumption at the brake resistor 5 is prioritized and controlled. In this case, since electric power that has been consumed by the brake resistor 5 is charged to the battery 3, fuel efficiency is improved, and since the SOC is controlled high, power performance can also be secured.

An estimated value of the ECU 1 may be used for vehicle weight to estimate necessary regenerative output. A limit vehicle speed of a travel route may be used for vehicle speed.

Necessary braking force=−(gradient resistance+air resistance+rolling resistance) [N]
F=−(M*g*sinθ+λ*A*V²+μ*M*g)
θ: road gradient [deg], M: vehicle weight [kg], λ: air resistance coefficient [kg/m²/(km/h)²], A: frontal projected area [m], V: vehicle speed [km], μ: rolling resistance coefficient

Necessary regenerative output may be calculated for each vehicle speed from the above braking force. Since the above regenerative output becomes necessary regenerative output on an output shaft of the motor 4, necessary regenerative output at a DC power terminal of an inverter may be calculated using efficiencies of each gear, the motor 4, and the inverter.

Based on navigation information, when the control unit 11 determines that an uphill is ahead, the control unit 11 may change the SOC threshold high, and when the control unit 11 determines that a downhill is ahead, the control unit 11 may change the SOC threshold low (because braking force will be necessary).

Operational effects of the ECU 1 will be described below.

The ECU 1 includes a control unit 11 configured to control, based on the SOC of the battery 3, a priority of distribution of regenerative electric power in the fuel cell vehicle V including the battery 3 and the brake resistor 5, the distribution being to charging the battery 3 to the continuous rating or to a charge amount lower than the continuous rating, charging the battery 3 to the short-time rating, or electric power consumption at the brake resistor 5. In such a configuration, the priority of distribution of regenerative electric power in the fuel cell vehicle V, the distribution being to charging the battery 3 to the continuous rating or to a charge amount lower than the continuous rating, charging the battery 3 to the short-time rating, or electric power consumption at the brake resistor 5, is controlled based on the SOC of the battery 3. Thereby, distribution of regenerative electric power is controlled in consideration of the continuous rating or the short-time rating of the battery 3. That is, distribution of regenerative electric power can be more appropriately controlled.

In the ECU 1, the control unit 11 may control the priority based on comparison between the SOC and one or more predetermined thresholds. In such a configuration, distribution of regenerative electric power can be more simply and more reliably controlled based on comparison between the SOC and the threshold.

In the ECU 1, the control unit 11 may change at least one of one or more thresholds based on regenerative electric power required by the fuel cell vehicle V. In such a configuration, distribution of regenerative electric power can be more appropriately controlled based on regenerative electric power required by the fuel cell vehicle V.

In the ECU 1, when the SOC is smaller than SOC_A, the control unit 11 may prioritize charging (the battery 3) to the continuous rating or to a charge amount (lower than the continuous rating) over charging (the battery 3) to the short-time rating. Generally, at a low SOC, since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is smaller than SOC_A, the control unit 11 may prioritize charging (the battery 3) to the short-time rating over electric power consumption (at the brake resistor 5). Generally, at a low SOC, since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is smaller than SOC_A, the control unit 11 may prioritize charging (the battery 3) to the continuous rating or to a charge amount (lower than the continuous rating) over electric power consumption (at the brake resistor 5). Generally, at a low SOC, since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is greater than SOC_A and smaller than SOC_B, the control unit 11 may prioritize charging (the battery 3) to the continuous rating or to a charge amount (lower than the continuous rating) over electric power consumption (at the brake resistor 5). Generally, at a medium SOC (as compared with a high SOC), since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is greater than SOC_A and smaller than SOC_B, the control unit 11 may prioritize electric power consumption (at the brake resistor 5) over charging (the battery 3) to the short-time rating. Generally, at a medium SOC (as compared with a high SOC), since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is greater than SOC_A and smaller than SOC_B, the control unit 11 may prioritize charging (the battery 3) to the continuous rating or to a charge amount (lower than the continuous rating) over charging (the battery 3) to the short-time rating. Generally, at a medium SOC (as compared with a high SOC), since the continuous rating is large, braking force is unlikely to be insufficient. In such a configuration, distribution of regenerative electric power can be more appropriately controlled, for example, braking force can be secured, a margin of the short-time rating can be secured, and fuel consumption can be reduced.

In the ECU 1, when the SOC is greater than SOC_B, the control unit 11 may prioritize electric power consumption (at the brake resistor 5) over charging (the battery 3) to the continuous rating or to a charge amount (lower than the continuous rating). In such a configuration, distribution of regenerative electric power can be more appropriately controlled, for example, a margin of the short-time rating can be secured, and thereby braking force can be secured.

In the ECU 1, when the SOC is greater than SOC_B, the control unit 11 may prioritize charging (the battery 3) to the continuous rating or to a charge amount (lower than the continuous rating) over charging (the battery 3) to the short-time rating. In such a configuration, distribution of regenerative electric power can be more appropriately controlled, for example, a margin of the short-time rating can be secured, and thereby braking force can be secured.

In the ECU 1, when the SOC is greater than SOC_B, the control unit 11 may prioritize electric power consumption (at the brake resistor 5) over charging (the battery 3) to the short-time rating. In such a configuration, distribution of regenerative electric power can be more appropriately controlled, for example, a margin of the short-time rating can be secured, and thereby braking force can be secured.

In the ECU 1, the control unit 11 may change at least one of SOC_A and SOC_B based on regenerative electric power required by the fuel cell vehicle V. In such a configuration, distribution of regenerative electric power can be more appropriately controlled based on regenerative electric power required by the fuel cell vehicle V.

According to the ECU 1, with a minimum system configuration including the battery 3 and the brake resistor 5, regenerative braking force necessary for the fuel cell vehicle V is secured, and securing of driving force and suppression of deterioration of fuel efficiency can be achieved together. According to the ECU 1, by variably controlling the priority of distribution of regenerative power to charging the battery 3 and consumption at the brake resistor 5 according to the SOC of the battery 3, the frequency and region where target braking force is insufficient can be reduced. Since regenerative power depends on road gradient during travel, the ECU 1 may be configured to acquire information from, for example, a GPS device, a navigation system, or traffic jam information, and variably control the SOC threshold.

According to the ECU 1, the frequency of insufficient regenerative braking force is reduced by reducing the frequency of reaching high SOC at which regenerative braking force decreases. According to the ECU 1, the frequency of battery 3 charging limit electric power decreasing to the continuous rating at high SOC is reduced, and when regenerative power is needed, battery 3 charging can be used up to the short-time rating, and the frequency of insufficient regenerative braking force is reduced. According to the ECU 1, since battery 3 charging is prioritized at low SOC, securing of driving force and suppression of deterioration of fuel efficiency can be achieved together.

The ECU 1 may have a main purpose of securing braking force and a purpose of achieving both securing braking force and fuel consumption reduction. According to the ECU 1, in order to supplement necessary regenerative output and descent continuation time on an actual travel route by charging using the battery 3 short-time rating, in order to secure short-time rating electric power and continuation time as a margin, the priority of distribution of consumption at the brake resistor 5 and the continuous rating (or a charge amount lower than the continuous rating) and the short-time rating of the battery 3 can be changed. According to the ECU 1, the SOC is divided into three conditions as means, and the priority of electric power distribution is changed. According to the ECU 1, only charging the battery 3, charging the battery 3 and consumption at the brake resistor 5, and only consumption at the brake resistor 5 can be switched according to the SOC and required regenerative force.

The ECU 1 of the disclosure may have the following configurations.

[1] A power management device including a control unit configured to control, based on a state of charge of a battery, a priority of distribution of regenerative electric power in an electric vehicle including the battery and an electric power device, the distribution being to:
charging the battery to a continuous rating or to a charge amount lower than the continuous rating;
charging the battery to a short-time rating; or
electric power consumption at the electric power device.

[2] The power management device according to [1], wherein the control unit controls the priority based on comparison between the state of charge and one or more predetermined thresholds.

[3] The power management device according to [2], wherein the control unit changes at least one of the one or more thresholds based on the regenerative electric power required by the electric vehicle.

[4] The power management device according to any one of [1] to [3], wherein when the state of charge is smaller than a predetermined threshold, the control unit prioritizes charging to the continuous rating or to a charge amount lower than the continuous rating over charging to the short-time rating.

[5] The power management device according to any one of [1] to [4], wherein when the state of charge is smaller than a predetermined threshold, the control unit prioritizes charging to the short-time rating over the electric power consumption.

[6]0 The power management device according to any one of [1] to [5], wherein when the state of charge is smaller than a predetermined threshold, the control unit prioritizes charging to the continuous rating or to a charge amount lower than the continuous rating over the electric power consumption.

[7] The power management device according to any one of [1] to [6], wherein when the state of charge is greater than a predetermined first threshold and smaller than a predetermined second threshold, the control unit prioritizes charging to the continuous rating or to a charge amount lower than the continuous rating over the electric power consumption.

[8] The power management device according to any one of [1] to [7], wherein when the state of charge is greater than a predetermined first threshold and smaller than a predetermined second threshold, the control unit prioritizes the electric power consumption over charging to the short-time rating.

[9] The power management device according to any one of [1] to [8], wherein when the state of charge is greater than a predetermined first threshold and smaller than a predetermined second threshold, the control unit prioritizes charging to the continuous rating or to a charge amount lower than the continuous rating over charging to the short-time rating.

[10] The power management device according to any one of to [9], wherein when the state of charge is greater than a predetermined threshold, the control unit prioritizes the electric power consumption over charging to the continuous rating or to a charge amount lower than the continuous rating.

[11] The power management device according to any one of [1] to [10], wherein when the state of charge is greater than a predetermined threshold, the control unit prioritizes charging to the continuous rating or to a charge amount lower than the continuous rating over charging to the short-time rating.

[12] The power management device according to any one of to [11], wherein when the state of charge is greater than a predetermined threshold, the control unit prioritizes the electric power consumption over charging to the short-time rating.

[13] The power management device according to any one of to [6] and [10] to [12], wherein the control unit changes the threshold based on the regenerative electric power required by the electric vehicle.

[14] The power management device according to any one of to [9], wherein the control unit changes at least one of the first threshold and the second threshold based on the regenerative electric power required by the electric vehicle.

### REFERENCE SIGNS LIST

1: ECU, 2: fuel cell, 3: battery, 4: motor, 5: brake resistor, 6: auxiliary device, 7: tire, 10: storage unit, 11: control unit, V: fuel cell vehicle.

What is claimed is:

1. A power management device comprising a control unit configured to control, based on a state of charge of a battery, a priority of distribution of regenerative electric power in an electric vehicle including the battery and an electric power device, the distribution being to:
charging the battery to a continuous rating or to a charge amount lower than the continuous rating;
charging the battery to a short-time rating; or
electric power consumption at the electric power device.

2. The power management device according to claim 1, wherein the control unit controls the priority based on comparison between the state of charge and one or more predetermined thresholds.

3. The power management device according to claim 2, wherein the control unit changes at least one of the one or more thresholds based on the regenerative electric power required by the electric vehicle.

4. The power management device according to claim 1, wherein when the state of charge is smaller than a predetermined threshold, the control unit prioritizes charging to the continuous rating or to a charge amount lower than the continuous rating over charging to the short-time rating.

5. The power management device according to claim 1, wherein when the state of charge is smaller than a predetermined threshold, the control unit prioritizes charging to the short-time rating over the electric power consumption.

6. The power management device according to claim 1, wherein when the state of charge is smaller than a predetermined threshold, the control unit prioritizes charging to the continuous rating or to a charge amount lower than the continuous rating over the electric power consumption.

7. The power management device according to claim 1, wherein when the state of charge is greater than a predetermined first threshold and smaller than a predetermined second threshold, the control unit prioritizes charging to the continuous rating or to a charge amount lower than the continuous rating over the electric power consumption.

8. The power management device according to claim 1, wherein when the state of charge is greater than a predetermined first threshold and smaller than a predetermined second threshold, the control unit prioritizes the electric power consumption over charging to the short-time rating.

9. The power management device according to claim 1, wherein when the state of charge is greater than a predetermined first threshold and smaller than a predetermined second threshold, the control unit prioritizes charging to the continuous rating or to a charge amount lower than the continuous rating over charging to the short-time rating.

10. The power management device according to claim 1, wherein when the state of charge is greater than a predetermined threshold, the control unit prioritizes the electric power consumption over charging to the continuous rating or to a charge amount lower than the continuous rating.

11. The power management device according to claim 1, wherein when the state of charge is greater than a predetermined threshold, the control unit prioritizes charging to the continuous rating or to a charge amount lower than the continuous rating over charging to the short-time rating.

12. The power management device according to claim 1, wherein when the state of charge is greater than a predetermined threshold, the control unit prioritizes the electric power consumption over charging to the short-time rating.

13. The power management device according to claim 4, wherein the control unit changes the threshold based on the regenerative electric power required by the electric vehicle.

14. The power management device according to claim 7, wherein the control unit changes at least one of the first threshold and the second threshold based on the regenerative electric power required by the electric vehicle.
